(19) United States
(12) Patent Application Publication
(10) Pub. No.: US 2024/0297469 A1
(43) Pub. Date: Sep. 5, 2024

(54) SYSTEMS AND METHODS FOR SWITCHABLE AND RECONFIGURABLE INTERCONNECTIVITY

(71) Applicant: Dell Products L.P., Round Rock, TX (US)

(72) Inventor: Xin Zhi MA, Shanghai (CN)

(73) Assignee: Dell Products L.P., Round Rock, TX (US)

(21) Appl. No.: 18/187,251

(22) Filed: Mar. 21, 2023

(30) Foreign Application Priority Data
Mar. 3, 2023 (CN) 202310207510.5

(51) Int. Cl. H01R 29/00; H01R 43/26

(52) U.S. Cl. CPC H01R 29/00; H01R 43/26; H01R 12/73; H01R 12/75; H01R 2201/04

(57) ABSTRACT

A connector configured to couple to a second connector may include a first set of pins, each of the first set of pins coupled to a corresponding first signal, and a second set of pins, each of the second set of pins coupled to a corresponding second signal conductor. The first and second set of pins may be arranged relative to one another such that when the connector and the second connector are coupled to one another in a first position relative to one another, each of the first set of pins electrically couples to a corresponding pin of a plurality of pins of the second connector and when the connector and the second connector are coupled to one another in a second position relative to one another, each of the second set of pins electrically couples to a corresponding pin of a plurality of pins of the second connector.

### TECHNICAL FIELD

The present disclosure relates in general to information handling systems, and more particularly to systems and methods for switchable and reconfigurable interconnectivity among information handling resources, in accordance with embodiments of the present disclosure.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

An information handling system may use dual-socket or multi-socket designs to achieve desired compute and input/output (I/O) density, with I/O connectors and interfaces communicatively coupled to a fixed processor on a motherboard. However, different users may have differing requirements or desires to communicatively coupling network cards or other peripherals to different processors to meet workload and configuration requirements. Further, some users may desire to reconfigure information handling systems to change configuration of network connections from one processor to another. Such requirements may present challenges for server baseboard-level and stream-level designs, and may present challenges for using Open Compute Platform (OCP)-based form factor network interface cards or other form factors.

### SUMMARY

In accordance with the teachings of the present disclosure, the disadvantages and problems associated with traditional approaches to networked connectivity may be reduced or eliminated.

In accordance with embodiments of the present disclosure, a connector configured to couple to a second connector may include a first set of pins, each of the first set of pins coupled to a corresponding first signal conductor of the connector, and a second set of pins, each of the second set of pins coupled to a corresponding second signal conductor of the connector. The first set of pins and the second set of pins may be arranged relative to one another such that when the connector and the second connector are coupled to one another in a first position relative to one another, each of the first set of pins electrically couples to a corresponding pin of a plurality of pins of the second connector and when the connector and the second connector are coupled to one another in a second position relative to one another, each of the second set of pins electrically couples to a corresponding pin of a plurality of pins of the second connector.

In accordance with these and other embodiments of the present disclosure, a method may include forming a connector configured to couple to a second connector such that the connector comprises a first set of pins, each of the first set of pins coupled to a corresponding first signal conductor of the connector, and a second set of pins, each of the second set of pins coupled to a corresponding second signal conductor of the connector. The method may also include arranging the first set of pins and the second set of pins relative to one another such that when the connector and the second connector are coupled to one another in a first position relative to one another, each of the first set of pins electrically couples to a corresponding pin of a plurality of pins of the second connector, and when the connector and the second connector are coupled to one another in a second position relative to one another, each of the second set of pins electrically couples to a corresponding pin of a plurality of pins of the second connector.

In accordance with these and other embodiments of the present disclosure, an information handling system may include a first information handling resource, a second information handling resource, and a connector configured to couple to a second connector. The connector may include a first set of pins, each of the first set of pins coupled to the first information handling resource via a corresponding first signal conductor of the connector and a second set of pins, each of the second set of pins coupled to the second information handling resource via a corresponding second signal conductor of the connector. The first set of pins and the second set of pins may be arranged relative to one another such that when the connector and the second connector are coupled to one another in a first position relative to one another, each of the first set of pins electrically couples to a corresponding pin of a plurality of pins of the second connector and when the connector and the second connector are coupled to one another in a second position relative to one another, each of the second set of pins electrically couples to a corresponding pin of a plurality of pins of the second connector.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of selected components of two connectors, in accordance with embodiments of the present disclosure;

FIG. 2A illustrates the connectors of FIG. 1 in a first configuration, in accordance with embodiments of the present disclosure;

FIG. 2B illustrates the connectors of FIG. 1 in a second configuration, in accordance with embodiments of the present disclosure;

FIG. 3A illustrates a block diagram of selected components of two circuit boards with their respective connectors decoupled from one another, in accordance with embodiments of the present disclosure;

FIG. 3B illustrates the two circuit boards of FIG. 3A with their respective connectors coupled to one another in a first configuration, in accordance with embodiments of the present disclosure;

FIG. 3C illustrates the two circuit boards of FIG. 3A with their respective connectors coupled to one another in a second configuration, in accordance with embodiments of the present disclosure;

FIG. 4A illustrates a block diagram of selected components of cables with their respective connectors decoupled from one another, in accordance with embodiments of the present disclosure;

FIG. 4B illustrates the cables of FIG. 4A with their respective connectors coupled to one another in a first configuration, in accordance with embodiments of the present disclosure;

FIG. 4C illustrates the cables of FIG. 4A with their respective connectors coupled to one another in a second configuration, in accordance with embodiments of the present disclosure;

FIG. 5A illustrates a block diagram of selected components of a cable and a circuit board with their respective connectors decoupled from one another, in accordance with embodiments of the present disclosure;

FIG. 5B illustrates the cable and the circuit board of FIG. 5A with their respective connectors coupled to one another in a first configuration, in accordance with embodiments of the present disclosure;

FIG. 5C illustrates the cable and the circuit board of FIG. 5A with their respective connectors coupled to one another in a second configuration, in accordance with embodiments of the present disclosure;

FIG. 6 illustrates an information handling system and a peripheral device with their respective connectors decoupled from one another, in accordance with embodiments of the present disclosure;

FIG. 7A illustrates an information handling system and a peripheral device with their respective connectors coupled to one another in a first configuration, in accordance with embodiments of the present disclosure; and

FIG. 7B illustrates an information handling system and a peripheral device with their respective connectors coupled to one another in a second configuration, in accordance with embodiments of the present disclosure.

### DETAILED DESCRIPTION

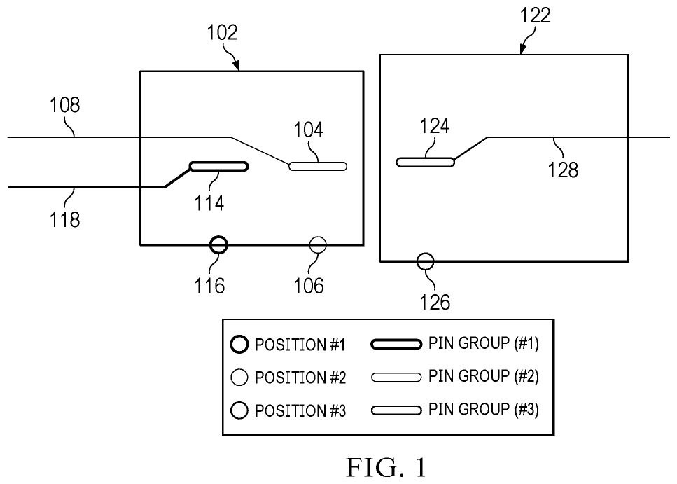

Preferred embodiments and their advantages are best understood by reference to FIGS. 1 through 7B, wherein like numbers are used to indicate like and corresponding parts.

For the purposes of this disclosure, an information handling system may include any instrumentality or aggregate of instrumentalities operable to compute, classify, process, retrieve, transmit, receive, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems (BIOSs), buses, memories, I/O devices and/or interfaces, storage resources, network interfaces, motherboards, and/or any other components and/or elements of an information handling system.

For the purposes of this disclosure, circuit boards may broadly refer to printed circuit boards (PCBs), printed wiring boards (PWBs), printed wiring assemblies (PWAs) etched wiring boards, and/or any other board or similar physical structure operable to mechanically support and electrically couple electronic components (e.g., packaged integrated circuits, slot connectors, etc.). A circuit board may comprise a substrate of a plurality of conductive layers separated and supported by layers of insulating material laminated together, with conductive traces disposed on and/or in any of such conductive layers, with vias for coupling conductive traces of different layers together, and with pads for coupling electronic components (e.g., packaged integrated circuits, slot connectors, etc.) to conductive traces of the circuit board.

FIG. 1 illustrates a block diagram of selected components of a connector 102 and a connector 122, in accordance with embodiments of the present disclosure. Each connector 102, 122 may comprise any suitable system, device, or apparatus configured to couple to the other of connector 102, 122, in order to provide electrical and/or communicative coupling between information handling resources communicatively coupled to connector 102 and information handling resources communicatively coupled to connector 122. In some embodiments, one of connector 102 and 122 may comprise a “male” connector that terminates a cable. In some embodiments, one of connector 102 and 122 may comprise a “female” connector that terminates a cable. In these and other embodiments, one of connector 102 and 122 may comprise a connector mounted to a surface of a circuit board (e.g., a receptacle connector). In these and other embodiments, one of connector 102 and 122 may comprise a connector mounted to an edge of a circuit board (e.g., an edge connector).

As shown in FIG. 1, connector 102 may include a first pin 104 located at a first position 106 within connector 102 and electrically coupled to a first signal conductor 108. First pin 104 may comprise an electrically-conductive material, such as copper, silver, gold, aluminum, or other metal. Likewise, first signal conductor 108 may comprise an electrically-conductive material, such as copper, silver, gold, aluminum, or other metal. First signal conductor 108 may comprise a circuit board trace, wire (e.g., within a cable), and/or other electrically-conductive conduit.

Further, connector 102 may include a second pin 114 located at a second position 116 within connector 102 and electrically coupled to a second signal conductor 118. Second pin 114 may comprise an electrically-conductive material, such as copper, silver, gold, aluminum, or other metal. Likewise, second signal conductor 118 may comprise an electrically-conductive material, such as copper, silver, gold, aluminum, or other metal. Second signal conductor 118 may comprise a circuit board trace, wire (e.g., within a cable), and/or other electrically-conductive conduit.

In addition, connector 122 may include a pin 124 located at a position 126 within connector 122 and electrically coupled to a signal conductor 128. Pin 124 may comprise an electrically-conductive material, such as copper, silver, gold, aluminum, or other metal. Likewise, signal conductor 128 may comprise an electrically-conductive material, such as copper, silver, gold, aluminum, or other metal. Signal conductor 128 may comprise a circuit board trace, wire (e.g., within a cable), and/or other electrically-conductive conduit.

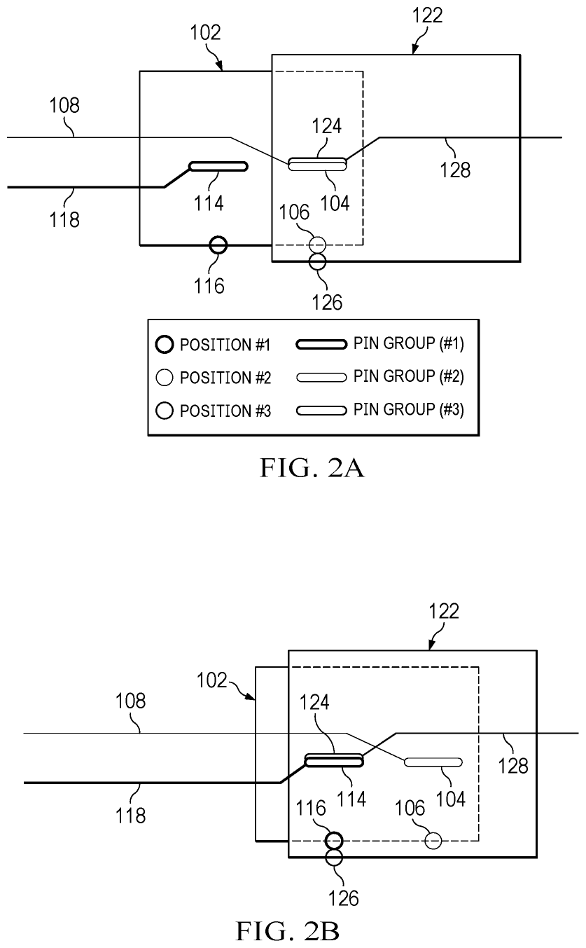

FIG. 1 depicts connector 102 decoupled from connector 122. However, connector 102 may be coupled to connector 122 in a first configuration, as shown in FIG. 2A, or in a second configuration, as shown in FIG. 2B.

In the first configuration, connector 102 may be inserted into connector 122 (or alternatively, connector 122 inserted into connector 102) such that first position 106 aligns with position 126, enabling first pin 104 to mechanically and electrically engage with pin 124, thus electrically coupling first signal conductor 108 to signal conductor 128 (while providing no coupling between second signal conductor 118 and signal conductor 128).

Similarly, in the second configuration, connector 102 may be inserted into connector 122 (or alternatively, connector 122 inserted into connector 102) such that second position 116 aligns with position 126, enabling second pin 114 to mechanically and electrically engage with pin 124, thus electrically coupling second signal conductor 118 to signal conductor 128 (while providing no coupling between first signal conductor 108 and signal conductor 128).

Although not explicitly shown in FIGS. 2A and 2B and although not within the scope of this disclosure, connectors 102 and/or connector 122 may include one or more mechanical features (e.g., mechanical latches, mechanical stops, etc.), configured to mechanically retain connectors 102 and 122 in either of the first configuration and the second configuration, as desired.

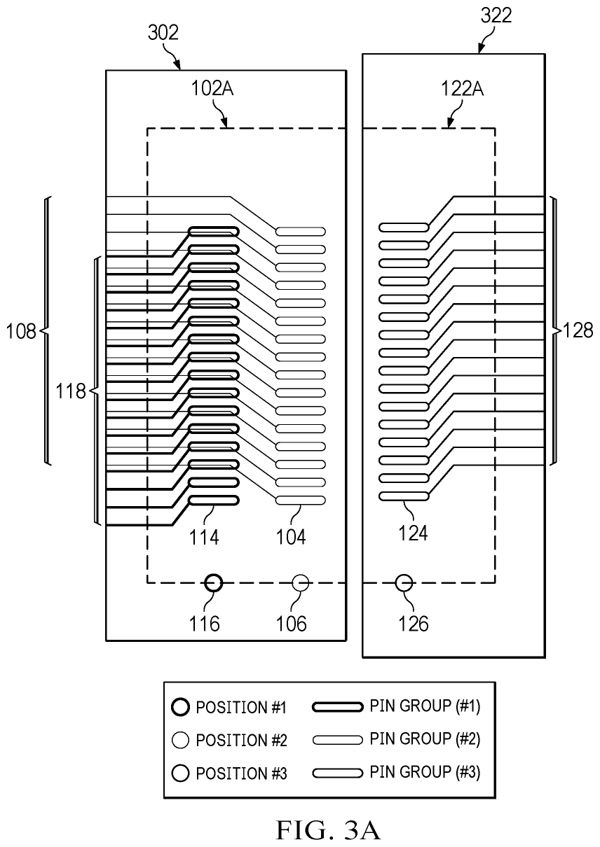

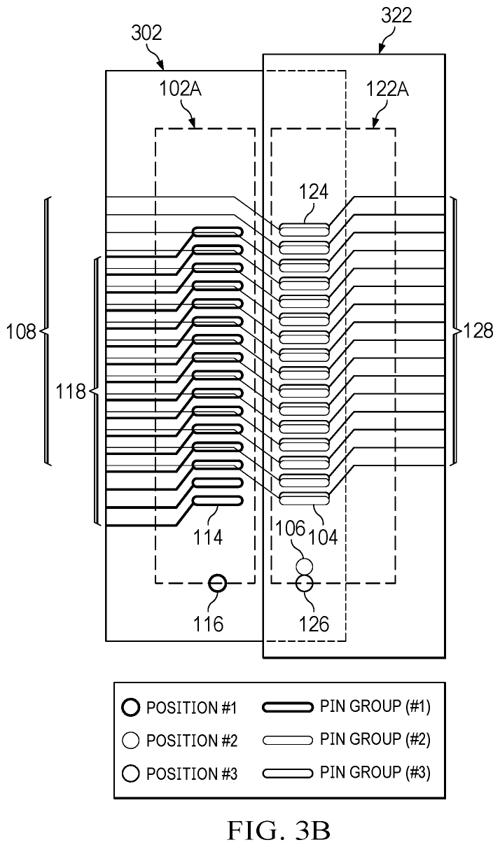

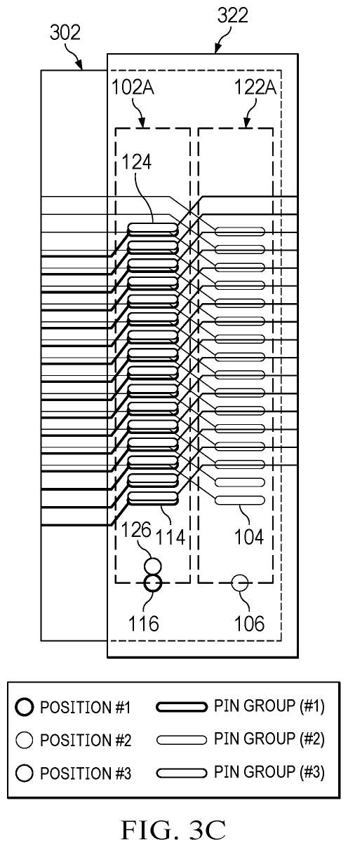

While the foregoing discussion contemplates, for the purposes of clarity and exposition, connector 102 having two pins 104 and 114 and connector 122 having one pin 124, in actual implementation, connector 102 may have a first plurality of first pins 104 and a second plurality of second pins 114 and connector 122 may have a plurality of pins 124, with connectors 102 and 122 switchable and reconfigurable as described above in order to couple connector 102 and connector 122 in one of a first configuration in which each pin of the plurality of first pins 104 are coupled to a respective pin of the plurality of pins 124 and a second configuration in which each pin of the plurality of second pins 114 are coupled to a respective pin of the plurality of pins 124. Examples of such implementations are depicted in FIGS. 3A-6 and described in greater detail below.

For example, FIGS. 3A-3C depict switchable and reconfigurable coupling between connector 102A of a circuit board 302 and connector 122A of a circuit board 322, with FIG. 3A depicting connectors 102A and 122A decoupled from one another, FIG. 3B depicting connectors 102A and 122A coupled to one another in a first configuration, and FIG. 3C depicting connectors 102A and 122A coupled to one another in a second configuration.

In the first configuration, each pin 104 of connector 102A may electrically couple to a corresponding pin 124 of connector 122A, thus electrically coupling each signal conductor 108 of circuit board 302 with a corresponding signal conductor 128 of circuit board 322. Likewise, in the second configuration, each pin 114 of connector 102A may electrically couple to a corresponding pin 124 of connector 122A, thus electrically coupling each signal conductor 118 of circuit board 302 with a corresponding signal conductor 128 of circuit board 322.

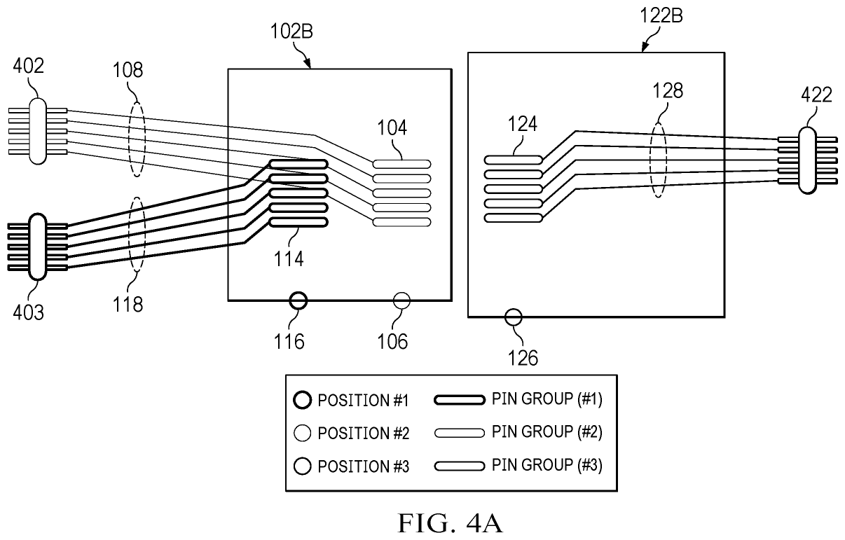

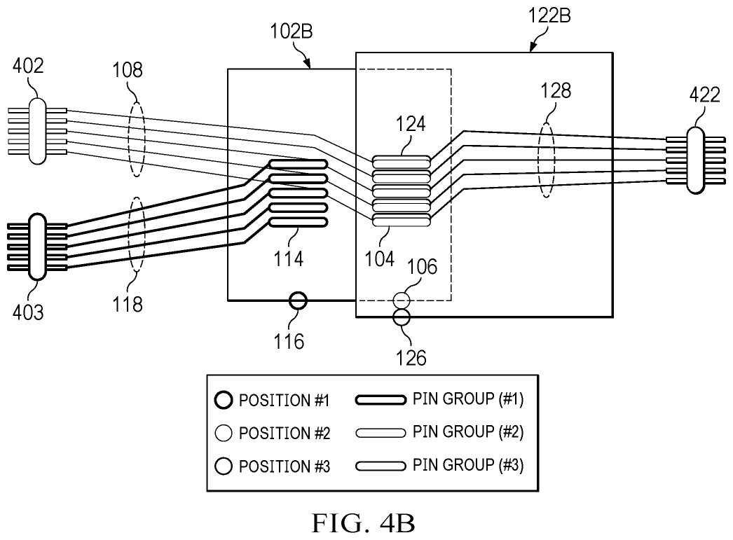

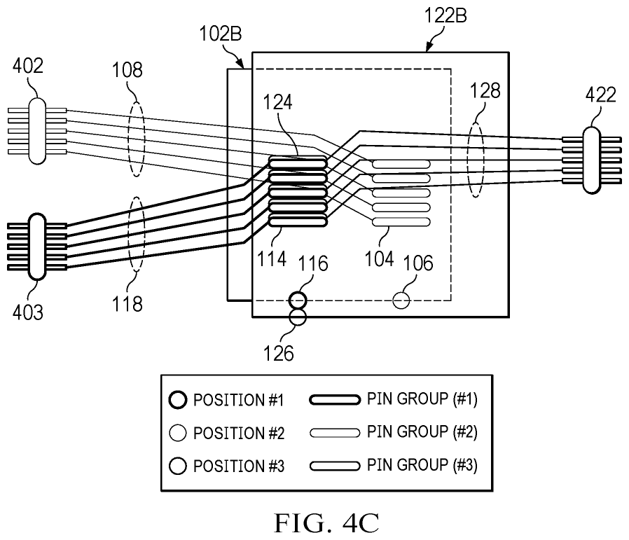

As another example, FIGS. 4A-4C depict switchable and reconfigurable coupling between a connector 102B terminating a first cable 402 and a second cable 403 and a connector 122B terminating a cable 422, with FIG. 4A depicting connectors 102B and 122B decoupled from one another, FIG. 4B depicting connectors 102B and 122B coupled to one another in a first configuration, and FIG. 4C depicting connectors 102B and 122B coupled to one another in a second configuration.

In the first configuration, each pin 104 of connector 102B may electrically couple to a corresponding pin 124 of connector 122B, thus electrically coupling each signal conductor 108 of cable 402 with a corresponding signal conductor 128 of cable 422. Likewise, in the second configuration, each pin 114 of connector 102B may electrically couple to a corresponding pin 124 of connector 122B, thus electrically coupling each signal conductor 118 of cable 403 with a corresponding signal conductor 128 of cable 422.

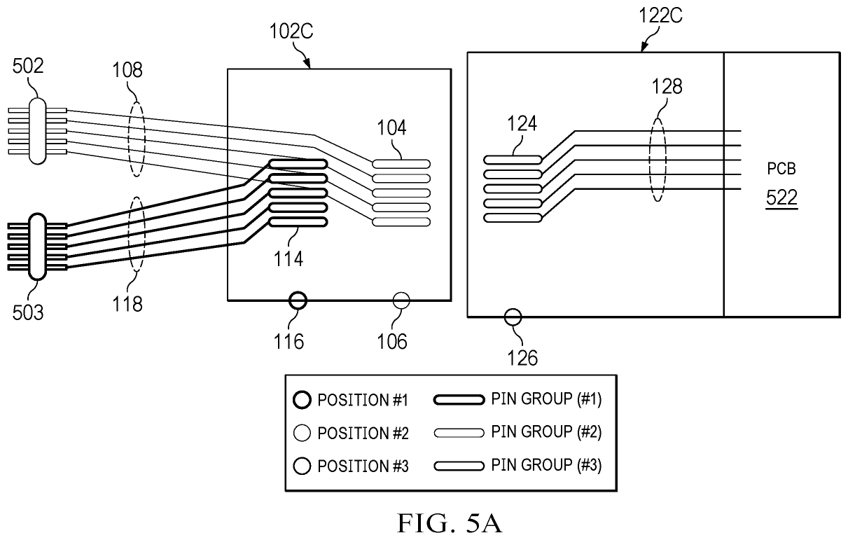

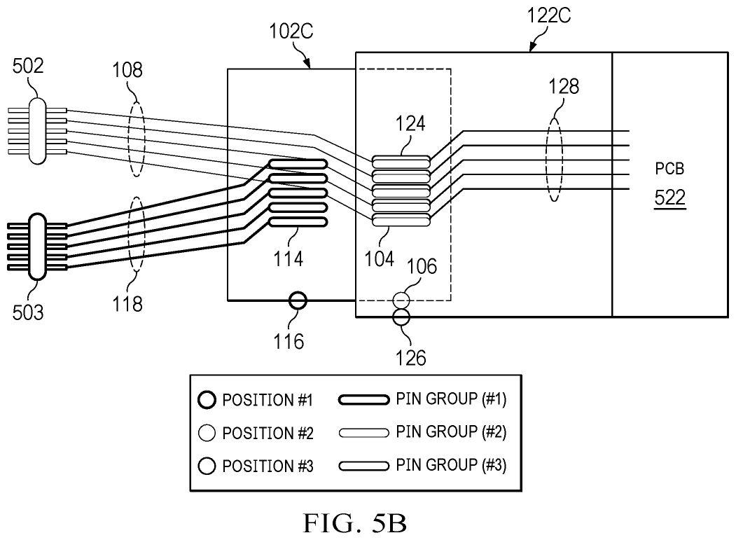

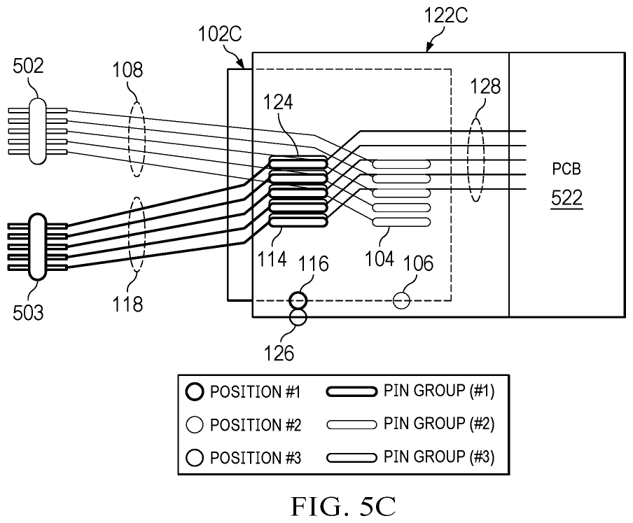

As a further example, FIGS. 5A-5C depict switchable and reconfigurable coupling between a connector 102C terminating a first cable 502 and a second cable 503 and a connector 122C of a circuit board 522, with FIG. 5A depicting connectors 102C and 122C decoupled from one another, FIG. 5B depicting connectors 102C and 122C coupled to one another in a first configuration, and FIG. 5C depicting connectors 102C and 122C coupled to one another in a second configuration.

In the first configuration, each pin 104 of connector 102C may electrically couple to a corresponding pin 124 of connector 122C, thus electrically coupling each signal conductor 108 of cable 502 with a corresponding signal conductor 128 of circuit board 522. Likewise, in the second configuration, each pin 114 of connector 102C may electrically couple to a corresponding pin 124 of connector 122C, thus electrically coupling each signal conductor 118 of cable 503 with a corresponding signal conductor 128 of circuit board 522. In some applications, it may be possible to establish connectivity and switching between signals on cable 502 and multiple signal groups on circuit board 522.

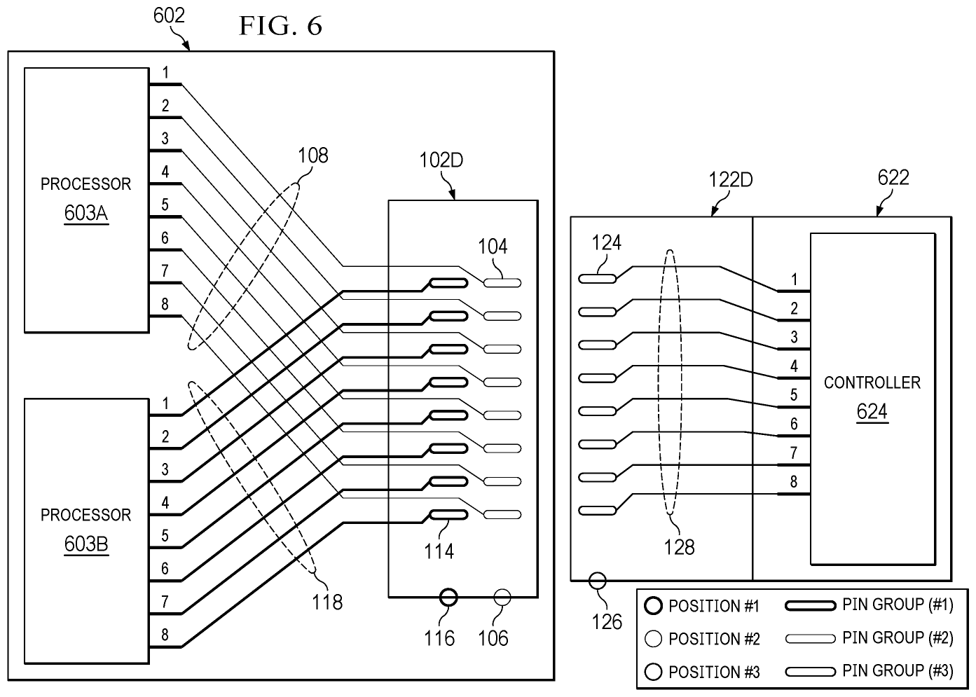

As an additional example, FIG. 6 illustrates an information handling system 602 and a peripheral device 622 with their respective connectors 102D and 122D decoupled from one another, in accordance with embodiments of the present disclosure. As shown in FIG. 6, information handling system 602 may include a processor 603A communicatively coupled to pins 104 via signal conductors 108 and a processor 603B communicatively coupled to pins 114 via signal conductors 118. Also as shown in FIG. 6, peripheral device 622 may include a controller 624 communicatively coupled to pins 124 via signal conductors 128. As an example, peripheral device 622 may be a network controller.

In a first configuration, each pin 104 of connector 102D may electrically couple to a corresponding pin 124 of connector 122D, thus electrically coupling each signal conductor 108 of information handling system 602 with a corresponding signal conductor 128 of peripheral device 622, and coupling processor 603A to controller 624. Likewise, in the second configuration, each pin 114 of connector 102D may electrically couple to a corresponding pin 124 of connector 122D, thus electrically coupling each signal conductor 118 of information handling system 602 with a corresponding signal conductor 128 of peripheral device 622, and coupling processor 603B to controller 624.

While, for purposes of clarity and exposition, the foregoing discussion contemplates only two configurations for interconnectivity between connectors, it is understood that some embodiments may include more than two configurations, in which a first connector may couple to a second connector at one of a plurality of positions relative to one another and wherein each of the plurality of positions provides for different connectivity between signal conductors coupled to each of the first connector and second connector.

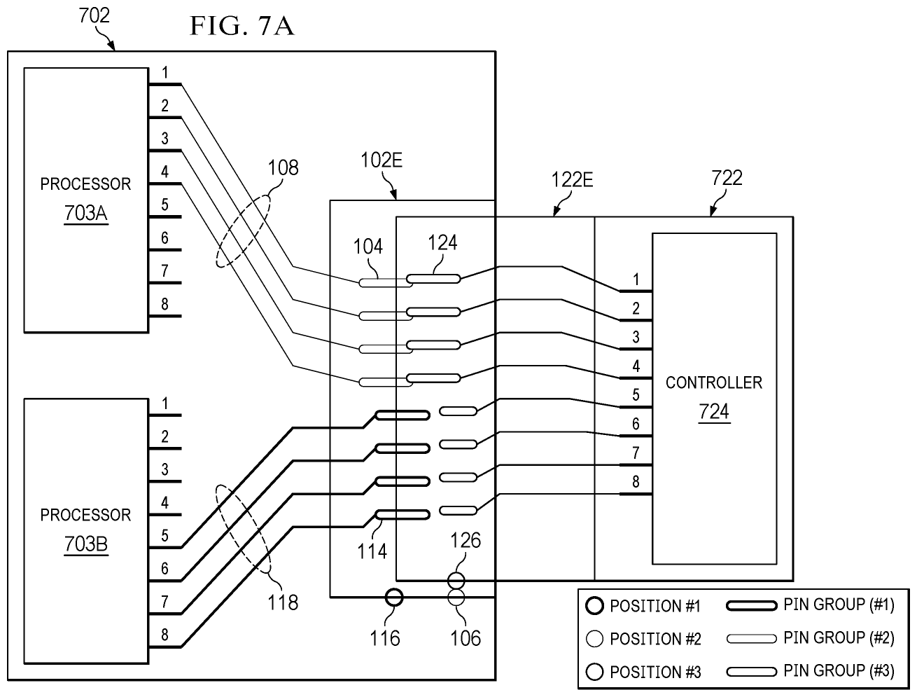

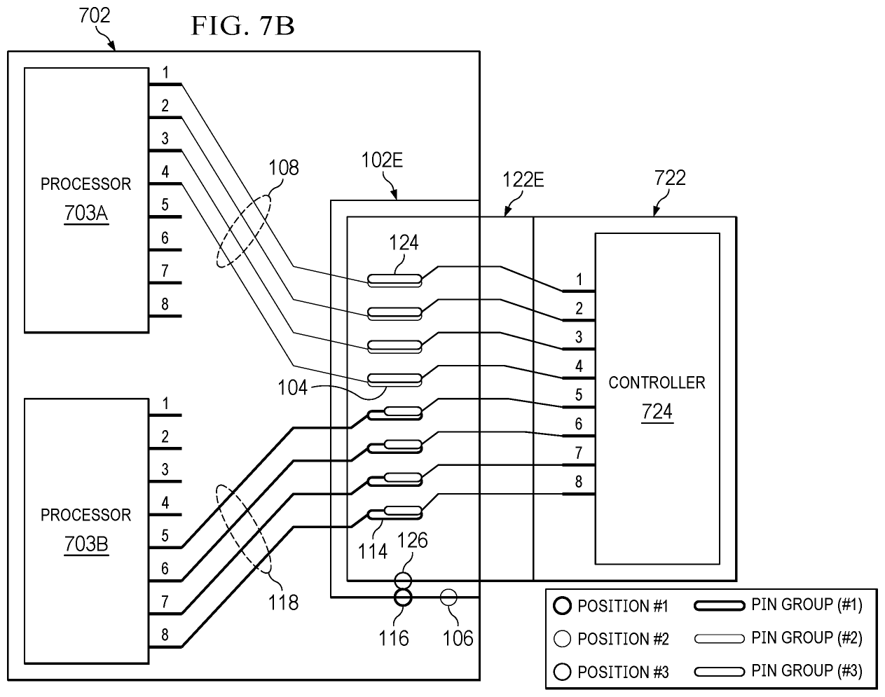

Further, while the foregoing discussion has contemplated embodiments in which pins of a first connector may couple to either a first set of pins or a second set of pins of a second connector, methods and systems similar to those disclosed above may also be applied to select between a configuration in which pins of a first connector may couple to either a single set of pins of a second connector in a first configuration or two (or more) sets of pins of the second connector in a second configuration, as shown in FIGS. 7A and 7B.

To further illustrate, FIG. 7A illustrates an information handling system 702 and a peripheral device 722 with their respective connectors 102E and 122E coupled to one another in a first configuration, in accordance with embodiments of the present disclosure. As shown in FIG. 7A, information handling system 702 may include a processor 703A communicatively coupled to pins 104 via signal conductors 108 and a processor 703B communicatively coupled to pins 114 via signal conductors 118. Also as shown in FIG. 7A, peripheral device 722 may include a controller 724 communicatively coupled to pins 124 via signal conductors 128. As an example, peripheral device 722 may be a network controller.

In the first configuration, each pin 104 of connector 102E may electrically couple to a corresponding pin 124 of connector 122E (which may be a subset of pins 124 of connector 122E), thus electrically coupling each signal conductor 108 of information handling system 702 with a corresponding signal conductor 128 of peripheral device 722, and coupling processor 703A to controller 724. In a second configuration, as shown in FIG. 7B, each pin 104 of connector 102E may electrically couple to a corresponding pin 124 of connector 122E and each pin 114 of connector 102E may electrically couple to a corresponding pin 124 of connector 122E, thus electrically coupling each signal conductor 108 of information handling system 702 with a corresponding signal conductor 128 of peripheral device 722 and electrically coupling each signal conductor 118 of information handling system 702 with a corresponding signal conductor 128 of peripheral device 722, and therefore coupling both processor 703A and processor 703B to controller 724.

Although the foregoing contemplates examples of switchable and reconfigurable interconnection of a circuit board to a circuit board, a cable to a cable, and a circuit board to a cable, the system and methods disclosed herein are not limited to such examples, and may provide comprehensive coverage of a wide range of interconnection scenarios, including, without limitation, interconnections between a host and a device, a device to a device, a microchip to a microchip, a port to a port, and a signal to a signal.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112 (f) unless the words “means for” or “step for” are explicitly used in the particular claim.

What is claimed is:

1. A connector configured to couple to a second connector, the connector comprising:
a first set of pins, each of the first set of pins coupled to a corresponding first signal conductor of the connector; and
a second set of pins, each of the second set of pins coupled to a corresponding second signal conductor of the connector;
wherein the first set of pins and the second set of pins are arranged relative to one another such that:
when the connector and the second connector are coupled to one another in a first position relative to one another, each of the first set of pins electrically couples to a corresponding pin of a plurality of pins of the second connector; and
when the connector and the second connector are coupled to one another in a second position relative to one another, each of the second set of pins electrically couples to a corresponding pin of a plurality of pins of the second connector.

2. The connector of claim 1, wherein the first set of pins and the second set of pins are further arranged relative to one another such that when the connector and the second connector are coupled to one another in the second position relative to one another:
each of the first set of pins electrically couples to a corresponding pin of a first subset of the plurality of pins of the second connector; and
each of the second set of pins electrically couples to a corresponding pin of a second subset of the plurality of pins of the second connector.

3. The connector of claim 1, wherein the connector is configured to terminate cables electrically coupled to the first signal conductors and the second signal conductors of the connector.

4. The connector of claim 1, wherein the connector is a receptacle connector of a circuit board.

5. The connector of claim 1, wherein the connector is an edge connector of a circuit board.

6. A method comprising:
forming a connector configured to couple to a second connector such that the connector comprises a first set of pins, each of the first set of pins coupled to a corresponding first signal conductor of the connector, and a second set of pins, each of the second set of pins coupled to a corresponding second signal conductor of the connector; and
arranging the first set of pins and the second set of pins relative to one another such that:
when the connector and the second connector are coupled to one another in a first position relative to one another, each of the first set of pins electrically couples to a corresponding pin of a plurality of pins of the second connector; and
when the connector and the second connector are coupled to one another in a second position relative to one another, each of the second set of pins electrically couples to a corresponding pin of a plurality of pins of the second connector.

7. The method of claim 6, further comprising arranging the first set of pins and the second set of pins relative to one another such that when the connector and the second connector are coupled to one another in the second position relative to one another:
each of the first set of pins electrically couples to a corresponding pin of a first subset of the plurality of pins of the second connector; and
each of the second set of pins electrically couples to a corresponding pin of a second subset of the plurality of pins of the second connector.

8. The method of claim 6, wherein the connector is configured to terminate cables electrically coupled to the first signal conductors and the second signal conductors of the connector.

9. The method of claim 6, wherein the connector is a receptacle connector of a circuit board.

10. The method of claim 6, wherein the connector is an edge connector of a circuit board.

11. An information handling system comprising:
a first information handling resource;
a second information handling resource; and
a connector configured to couple to a second connector, the connector comprising:
a first set of pins, each of the first set of pins coupled to the first information handling resource via a corresponding first signal conductor of the connector; and
a second set of pins, each of the second set of pins coupled to the second information handling resource via a corresponding second signal conductor of the connector;
wherein the first set of pins and the second set of pins are arranged relative to one another such that:
when the connector and the second connector are coupled to one another in a first position relative to one another, each of the first set of pins electrically couples to a corresponding pin of a plurality of pins of the second connector; and
when the connector and the second connector are coupled to one another in a second position relative to one another, each of the second set of pins electrically couples to a corresponding pin of a plurality of pins of the second connector.

12. The information handling system of claim 11, wherein the first set of pins and the second set of pins are further arranged relative to one another such that when the connector and the second connector are coupled to one another in the second position relative to one another:
each of the first set of pins electrically couples to a corresponding pin of a first subset of the plurality of pins of the second connector; and
each of the second set of pins electrically couples to a corresponding pin of a second subset of the plurality of pins of the second connector.

13. The information handling system of claim 11, wherein the connector is configured to terminate cables electrically coupled to the first signal conductors and the second signal conductors of the connector.

14. The information handling system of claim 11, wherein the connector is a receptacle connector of a circuit board.

15. The information handling system of claim 11, wherein the connector is an edge connector of a circuit board.

16. The information handling system of claim 11, wherein:
the first information handling resource is a first processor; and
the second information handling resource is a second processor.

17. The information handling system of claim 16, wherein the second connector is integral to a network interface device.
